(19) United States
(12) Patent Application Publication
(10) Pub. No.: US 2004/0154198 A1
(43) Pub. Date: Aug. 12, 2004

(54) Revealing picture structure

(76) Inventor: Loung Sheng Lee, Taipei (TW)

Correspondence Address: BACON & THOMAS, PLLC, 625 SLATERS LANE, FOURTH FLOOR, ALEXANDRIA, VA, 22314

(21) Appl. No.: 10/361,499

(22) Filed: Feb. 11, 2003

(51) Int. Cl. G09F 7/00

(52) U.S. Cl. 40/487

(57) ABSTRACT

The present invention relates to a revealing picture structure for surface picture or three-dimensional picture. The present invention mainly consists of a covering body and a content body wherein the covering picture can be pushed apart unlimitedly using different methods to finally regain an original covered content body status. The picture designed in the lower level of the content body is the final picture to be revealed. Hence, the present invention provides a creative and interesting structure satisfying the desire of knowledge and improving manufacturing values.

### TECHNICAL RANGE

The present invention relates to a revealing picture structure especially one designed with revealing function for surface picture or three-dimensional picture.

### INVENTION BACKGROUND

Commonly used picture structures usually use scraping or pushing method to reveal covered picture. However, this structure cannot be returned to original status for continuous use and has to be thrown away after single use. This is a disadvantage for the usual user and much improvement is therefore needed.

Apart from the pushing method mentioned above, another commonly used method is the changing method just like models changing clothes. However, this method emphasizes on the display of the clothing and not on the final content being revealed.

### SUMMARY OF INVENTION

The present invention relates to a revealing picture structure mainly consisting of a covering body and a content body wherein the covering body can be pushed apart unlimitedly using different methods to finally regain an original covered content body status.

The present invention relates to a revealing picture structure mainly consisting of a covering body and a content body wherein the picture designed in the lower level of the content body is the last picture to be revealed.

The present invention relates to a revealing picture structure wherein the covering or the content body is not limited to surface or three-dimensional structures such as surface pictures or three-dimensional articles.

### MODE FOR CARRYING OUT INVENTION

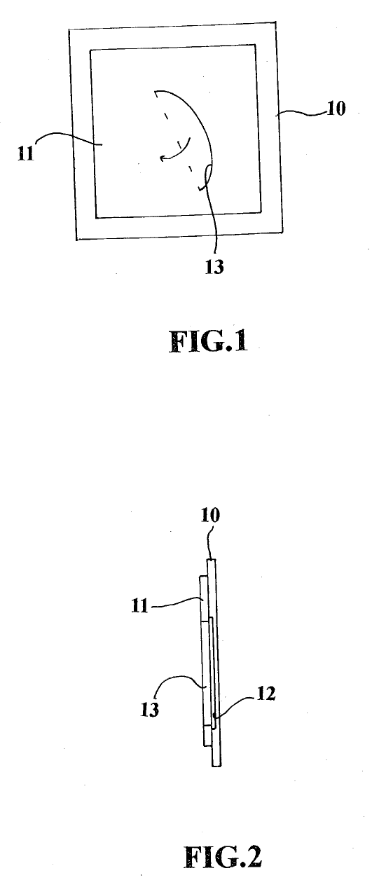

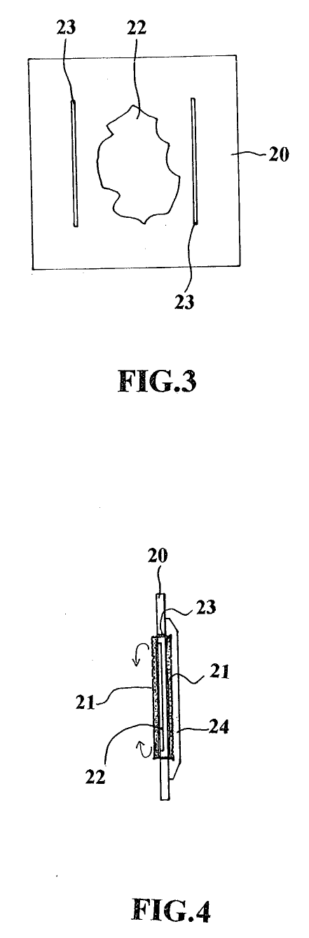

With reference to FIG. 1 and FIG. 2 showing a front view and a side sectional view of the present invention, the present invention mainly consists of a covering body 11 and a content body 12. Although covering body 11 is made up of an outside picture structure covering the content body 12 and the down level picture found inwards, the part to be revealed is designed with a curved active page 13. Although said active page 13 can be unlimitedly pushed apart, it automatically regains its covering function when active page is being released. With reference to FIG. 3 and FIG. 4 showing a front view (2) of the present invention in use and a side sectional view structure, covering body 21 is designed at the outer part of the content body, and slides into the vertical openings 23 found at both sides of the down level picture 20 and is secured at the reverse page 24. The covering body 21 is elastic and can automatically regain its original status after being pushed apart.

The two examples mentioned above are a simple description of the covering and content body of the present invention basic structure. Though the covering body is not limited to a single level structure, revealing method and force used and can also use machinery force such as fans or natural force such as wind, rain or the like, the covering content body has to regain its original status. The content body found inside the covering body is the last picture to be revealed and hence, the present invention provides a creative and interesting structure satisfying the desire of knowledge and improving manufacturing values.

### ILLUSTRATIONS OF DIAGRAMS

FIG. 1 shows a front view of the present invention in use (1).

FIG. 2 shows a side sectional view of the present invention in use (1).

FIG. 3 shows a front view of the present invention in use (2).

FIG. 4 shows a side sectional view of the present invention in use (2).

### NUMERICALS

10—down level picture 11—covering body

12—content body 13—active page

20—own level picture 21—covering body

22≦content body 23—vertical opening

24—reverse page

1. A “Revealing picture structure” mainly consisting of a covering body and a content body wherein:
Said covering body can be pushed apart unlimitedly using different methods to finally regain an original covered content body status;
The picture found inside said content body is the last picture to be revealed, as characterized:

2. As mentioned in claim 1 of a “Revealing picture structure”, said covering and content body is not limited to surface or three-dimensional structures such as surface pictures or three-dimensional articles.
